(19) United States
(12) Patent Application Publication
(10) Pub. No.: US 2026/0001221 A1
(43) Pub. Date: Jan. 1, 2026

(54) METHOD AND APPARATUS FOR COMPENSATING NON-GEOMETRIC ERROR INFLUENCES ON ROBOT ABSOLUTE ACCURACY USING A LASER SENSOR SYSTEM

(71) Applicants: Peter Kovács, Berlin (DE); ISIOS GmbH, Berlin (DE)

(72) Inventor: Peter Kovács, Berlin (DE)

(21) Appl. No.: 19/317,875

(22) Filed: Sep. 3, 2025

Related U.S. Application Data
(63) Continuation of application No. PCT/IB2024/052177, filed on Mar. 6, 2024.

(30) Foreign Application Priority Data
Mar. 7, 2023 (DE) 102023105674.3

(51) Int. Cl. B25J 9/16; B25J 13/08; B25J 19/02

(52) U.S. Cl. CPC B25J 9/1653; B25J 9/1607; B25J 9/163; B25J 9/1692; B25J 13/085; B25J 19/022; B25J 19/023

(57) ABSTRACT

A method for compensating non-geometric error influences on the absolute accuracy of a robot using a laser sensor system includes projecting at least one radiation pattern through the workspace, and selecting the measurement configurations such that, for at least one elasticity element, there is at least one pair of measurement configurations in which the absolute value of the difference in torques acting on the at least one elasticity element is greater than a threshold value. A deviation on a light-sensitive surface of at least one sensor) from a straight line and/or plane, which is implicitly defined by the radiation pattern, its direction and orientation, is taken into account by comparing the measured projection position with a calculated projection position based on faulty robot structure information. The corrected robot structure information is then derived to compensate for the non-geometric error influences.

### BACKGROUND OF THE INVENTION

Some aspects of the invention relate to a method for compensating non-geometric error influences on the absolute accuracy of a robot using a laser sensor system, as well as to a corresponding apparatus.

In the prior art, the term “mechanism” encompasses various types of robots, in particular industrial robots. These mechanisms are generally programmable machines that operate largely autonomously within a defined framework, for example to handle, assemble, or process workpieces. With appropriate programming, such a mechanism is capable of autonomously repeating a predetermined work sequence.

For a detailed explanation of the prior art and, in particular, for the definition of the terminology used herein, reference is made to the German patent application DE 10 2023 105 674.3 filed by the applicant, the full content of which is hereby incorporated by reference into the present application.

In addition to the definitions provided in DE 10 2023 105 674.3, the definition of the term “effector” (Section 2 of the definitions in DE 10 2023 105 674.3) is further explained as follows:

An effector is any defined segment or rigid body of the robot. In particular, an effector may be a complex, rigid, or internally movable component of a robot, on which a tool (e.g., a gripper for handling a workpiece, a milling cutter, a drill, a sensor such as a camera, etc.) can be arranged to perform a predefined task. The TCP (Tool Center Point) is a freely defined action point of a tool or workpiece mounted on the effector, for example the focus of a mounted laser or the center of a held object. In the literature, the effector is sometimes referred to as the “robot hand.”

In serial kinematics, i.e., in open kinematic chains, the effector is not necessarily the last element in the chain; additional elements such as joints or rigid bodies may follow the effector.

It is also conceivable in principle that a robot comprises more than one effector.

In previously used configurations of comparatively low-cost, locally measuring systems, certain non-geometric robot parameters or structural information of the robot cannot be identified with sufficient precision due to conceptual and unavoidable algebraic dependencies. These algebraic dependencies fundamentally result from the limitations of prior local measurement principles, rather than from deficiencies in measurement accuracy or in artificial intelligence or mathematical parameter identification methods.

In particular, elastic deformations are generally not comprehensively recorded by robot manufacturers and are typically only modeled in a rudimentary manner in robot controllers. Elasticity is a significant source of error in robots. If not properly identified and considered in the robot control system, it can substantially impair the achievable absolute accuracy of the robot.

Even when non-geometric parameters are determined using a local measurement method in the prior art, such as described in WO29/175 A1, it is not only necessary to conduct numerous measurements in various joint configurations and under various loads on a wide range of effector and reference objects; additionally, it is a strict requirement that the exact positions of the reference and effector objects relative to each other be known in advance. Thus, in such cases, at least one-time use of a globally measuring system is unavoidable. Such laser trackers or theodolite systems are, however, associated with high acquisition costs.

### SUMMARY OF THE INVENTION

Some aspects of the present invention provide a comparatively cost-effective, locally measuring method by which, in particular, non-geometric parameters of a robot can be precisely identified.

In some aspects of the invention, a method for compensating non-geometric error influences on the absolute accuracy of a robot using a laser sensor system, wherein the robot includes a plurality of elasticity elements and is controlled by a control unit, wherein an elasticity element of the plurality of elasticity elements is a rigid body, a joint, an effector, or a robot base, wherein at least one radiation pattern generator is stationarily arranged in an environment of the robot within or outside of a working space, the at least one radiation pattern generator configured to emit at least one radiation pattern by the at least one radiation pattern generator through the working space of the robot, the at least one radiation pattern including at least one laser beam or at least one laser light plane, wherein at least one sensor with at least one light-sensitive surface is arranged on the effector of the robot, wherein the robot is controlled via the control unit sequentially into a plurality of measurement configurations in which the at least one radiation pattern impinges on the at least one light-sensitive surface, wherein the robot is controlled according to robot structure information stored electronically in the control unit, wherein a position of a projection of the at least one radiation pattern on the at least one light-sensitive surface is detected by the at least one sensor, and measurement information describing the position is transmitted from the at least one sensor to a computation unit, wherein torques act on the elasticity elements due to an external force depending on the respective joint configuration, and wherein the robot structure information is erroneous due to non-geometric error influences, comprises emitting the at least one radiation pattern through the working space and selecting the plurality of measurement configurations in such a way that, for at least one elasticity element from the plurality of elasticity elements, there exists at least one pair of measurement configurations in which the absolute value of the difference of the torques at the at least one elasticity element is greater than a threshold value; determining a deviation on the light-sensitive surface of the at least one sensor from a line and/or plane, which is implicitly defined by the radiation pattern and its direction and orientation, by comparing, for the plurality of measurement configurations the position of the projection detected by the at least one sensor with a computed projection position based on the erroneous robot structure information; and generating corrected robot structure information from the deviation to compensate for the non-geometric error influences.

In some aspects of the invention, the method further comprises performing a model-based parameter identification by a computation unit, wherein the corrected robot structure information includes corrected model parameters of a mathematical model of the robot, the at least one radiation pattern generator, and the at least one sensor, wherein the model parameters include robot parameters describing the robot and calibration object parameters describing the at least one radiation pattern generator and the at least one sensor, wherein the plurality of measurement configurations include at least one measurement series, and wherein the at least one measurement series includes all measurement configurations recorded with a selected pair of calibration objects.

In some aspects of the invention, the method further comprises iteratively calculating the corrected robot parameters by the computation unit.

In some aspects of the invention, the corrected robot parameters are computed by the computation unit using a characteristic equation system, which may be represented in the form of a characteristic matrix equation, and the characteristic equation system is derived from a general kinematic equation system and additionally includes the position of the selected pair of calibration objects.

In some aspects of the invention, the characteristic equation system is expressed in the form:

$$P * L = G 0 * G 1 * … * Gn * S$$

wherein P describes a position of the at least one radiation pattern generator relative to the robot,
wherein L describes a direction of the at least one radiation pattern,
wherein G0*G1* . . . *Gn describes a spatial transformation from the robot base to the effector, each Gi represents a transformation from one rigid body of the robot to the next rigid body including the associated joint, or from one joint to the next joint including the intermediate rigid body,
wherein n denotes the number of joints of the robot, and
wherein S describes a spatial transformation from the effector of the robot to an arbitrary but fixed coordinate system on the light-sensitive surface of the at least one sensor.

In some aspects of the invention, a Jacobian matrix is generated by the computation unit based on the characteristic equation system, which computationally relates an infinitesimal change in the deviation to an infinitesimal change in the robot parameters. In some aspects of the invention, a pseudoinverse of the Jacobian matrix is computed by the computation unit.

In some aspects of the invention, the corrected robot parameters are calculated by the computation unit using model-based mathematical parameter identification, comprising at least one computation step executed as a nonlinear optimization.

In some aspects of the invention, the corrected robot structure information is contained in weighting matrices, and the weighting matrices are generated or parameterized by a machine learning method or by artificial intelligence.

In some aspects of the invention, the at least one radiation pattern generator is arranged such that an angle between a propagation direction of the at least one radiation pattern and a direction of gravity has a magnitude between 30° and 150°.

In some aspects of the invention, the at least one radiation pattern comprises at least two rigidly connected laser beams with an enclosed angle of less than 5 degrees, or at least two crossed light planes.

In some aspects of the invention, the threshold value amounts to 5% of the computationally maximum possible absolute value of all pairwise differences in torques that any pair of practically or theoretically measurable measurement configurations can have at the at least one elasticity element.

In some aspects of the invention, the external force is gravity, a compressive force, or a torsional force.

In some aspects of the invention, the robot is repeatedly controlled into the plurality of measurement configurations or subsets thereof with different additional weights or payloads.

In some aspects of the invention, an apparatus for compensating non-geometric error influences on an absolute accuracy of a robot using a laser sensor system comprises a control unit; a robot having a plurality of elasticity elements; at least one radiation pattern generator; and at least one sensor with at least one light-sensitive surface, wherein an elasticity element of the plurality of elasticity elements is a rigid body, a joint, an effector, or a robot base, wherein at least one radiation pattern generator is stationarily arranged in an environment of the robot within or outside of a working space, the at least one radiation pattern generator configured to emit at least one radiation pattern by the at least one radiation pattern generator through the working space of the robot, the at least one radiation pattern including at least one laser beam or at least one laser light plane, wherein the at least one radiation pattern comprises at least one laser beam or at least one laser light plane, wherein the at least one sensor with the at least one light-sensitive surface is arranged on the effector of the robot, wherein the control unit is configured to control the robot sequentially into a plurality of measurement configurations in which the at least one radiation pattern impinges on the at least one light-sensitive surface according to robot structure information stored electronically in the control unit, wherein the sensor is further configured to detect a position of a projection of the at least one radiation pattern on the at least one light-sensitive surface and to transmit measurement information describing the position to a computation unit, and wherein the control unit is configured to control the apparatus to emit the at least one radiation pattern through the working space and select the plurality of measurement configurations in such a way that, for at least one elasticity element from the plurality of elasticity elements, there exists at least one pair of measurement configurations in which the absolute value of the difference of the torques at the at least one elasticity element is greater than a threshold value; determine a deviation on the light-sensitive surface of the at least one sensor from a line and/or plane, which is implicitly defined by the radiation pattern and its direction and orientation, by comparing, for the plurality of measurement configurations the position of the projection detected by the at least one sensor with a computed projection position based on the erroneous robot structure information; and generate corrected robot structure information from the deviation to compensate for the non-geometric error influences.

In some aspects of the invention, the at least one sensor comprises a housing, a diffusion plate, and a matrix camera; the diffusion plate is a surface section of the housing and the matrix camera is enclosed by the housing; a refraction property of the diffusion plate is configured such that an incident light beam at an angle of 45° causes a displacement of a light spot of less than 0.3 mm between the front and rear sides of the plate; the matrix camera is arranged to capture an image of the diffusion plate; and the matrix camera is configured to output information about the captured image.

It should be noted, however, that the invention is not limited to the aspects detailed above.

### BRIEF DESCRIPTION OF THE DRAWINGS

FIG. 1 shows, by way of example and schematically, an apparatus for compensating non-geometric error influences on the absolute accuracy of a robot using a laser sensor system, according to some aspects of the invention.

FIG. 2 shows, by way of example and schematically, the robot in two different measurement configurations, according to some aspects of the invention.

FIG. 3 shows, by way of example and schematically, the robot from FIG. 2 in two additional, different measurement configurations, according to some aspects of the invention.

FIG. 4 shows, by way of example and schematically, another apparatus for compensating non-geometric error influences on the absolute accuracy of a robot, according to other aspects of the invention.

### DETAILED DESCRIPTION

Some aspects of the invention relate to a method for compensating non-geometric error influences on the absolute accuracy of a robot using a laser sensor system, wherein the robot comprises a plurality of elasticity elements and is controlled by a control unit, wherein an elasticity element may be a rigid body, a joint, an effector, or the robot base, wherein at least one radiation pattern generator is stationarily arranged in the environment of the robot, either within or outside the robot's workspace, wherein at least one radiation pattern is projected through the robot's workspace by the at least one radiation pattern generator, the pattern comprising at least one laser beam and/or at least one laser light plane, wherein at least one sensor with a light-sensitive surface is arranged on the effector of the robot, wherein the robot is sequentially guided into a plurality of measurement configurations by means of the control unit, such that the at least one radiation pattern impinges on the light-sensitive surface, wherein the robot is controlled based on robot structure information stored electronically in the control unit, wherein a projection position of the at least one radiation pattern on the light-sensitive surface is detected by the sensor and measurement information describing the projection position is transmitted to a computation unit, wherein torques act on the elasticity elements as a function of the respective joint configuration due to external forces, and wherein the robot structure information is erroneous due to non-geometric error influences.

In some aspects of the invention, the method is carried out as a laser sensor calibration, in which all measurement information necessary for calibration is detected and processed locally by sensors on the light-sensitive surfaces.

The robot to be calibrated comprises, in addition to a robot base that is arranged in a stationary manner within the workspace, a plurality of joints and rigid bodies, at least one effector, and, in some aspects of the invention, a control unit. In general, the robot has exactly one effector, but the method is not limited to robots with only one effector.

The joints may have various configurations, for example as rotary, translational, or helical joints. Furthermore, the joints preferably comprise electric actuators for moving the joints and the rigid bodies connected thereto.

The rigid bodies serve as fixed and immovable connection members in the form of arm segments between two joints.

The at least one effector is preferably connected via a joint to the outermost rigid body, i.e., the rigid body furthest from the robot base, and may support or operate a tool, a gripper, or even a workpiece. In particular, a gripper may be used to pick up a workpiece. As previously described, it is also conceivable—and indeed preferred—that the at least one effector is not the last element in the kinematic chain and that further elements follow the effector.

Since the joints, rigid bodies, robot base, and effector inherently exhibit unavoidable material elasticity, they are collectively referred to under the term “elasticity elements” within the meaning of some aspects of the invention.

Finally, the control unit may be connected to the remaining components of the robot solely at the data level, for example via one or more data cables or wirelessly. A physical connection beyond that is possible but not required. The control unit comprises an electronic computing unit or processor that executes instructions, which enable real-time control of the robot by converting motion requirements into corresponding actuation signals for the joints. The control unit may be a part of the robot, or a part of the apparatus.

Spaced apart from the robot base—or more generally from the robot itself—at least one radiation pattern generator is arranged within the robot's workspace and/or additionally or alternatively outside the workspace. The at least one radiation pattern generator is stationary, i.e., fixed in position and immobile at least for the duration of the execution of the method according to some aspects of the invention.

In contrast to known methods of the prior art, it is not necessary, according to some aspects of the invention, to know the exact position of the radiation pattern generator relative to the robot base. Advantageously, neither a laser tracker nor a theodolite system is required to determine this position.

The at least one radiation pattern generator is advantageously implemented as a laser, for example a semiconductor laser diode or a gas laser, in particular a HeNe laser, with a downstream optical system for generating a specific radiation pattern. The optical system may comprise one or more optical lenses or diffraction gratings.

The light emitted by the at least one radiation pattern generator constitutes the radiation pattern. It is not required for the radiation pattern to have a wavelength visible to the human eye. The wavelength may lie in the infrared or ultraviolet range.

At least one sensor with at least one light-sensitive surface is arranged on the effector. The at least one sensor is thus an optical sensor and may, for example, be a CCD sensor or a CMOS sensor, wherein the light-sensitive surface advantageously constitutes the corresponding sensor array. The light-sensitive surface of the at least one sensor preferably has a matrix structure that not only detects the impingement of the radiation pattern but also enables determination of the shape and position of the projection of the radiation pattern.

Alternatively, and preferably, the at least one sensor may comprise a housing, a diffusion plate, and a matrix camera. The diffusion plate forms a surface portion of the housing in which the matrix camera is arranged. The matrix camera may be directed at the diffusion plate and detect one or more incident radiation patterns. In this case, the matrix camera likewise allows the determination of the shape and the position of the projection of the radiation pattern.

However, the light-sensitive surface may also be a substantially one-dimensional line. In that case, the sensor is embodied as a so-called line sensor. The radiation pattern is then preferably a light plane.

The at least one sensor is configured to detect the position of the projection of the at least one radiation pattern when it impinges on the at least one light-sensitive surface. Accordingly, the light-sensitive surface is configured to detect all wavelengths of all radiation pattern generators used.

The position of a projection on the light-sensitive surface is captured by means of the at least one sensor. The term “projection position” as used herein includes the shape, orientation, and exact position of the at least one radiation pattern on the at least one light-sensitive surface. In the case of a non-point-shaped cross-section of the radiation pattern, the shape and orientation of the radiation pattern projection on the light-sensitive surface provides not only the position but also information about the orientation of the at least one sensor relative to the at least one radiation pattern generator. This orientation information may be advantageously used for calibration.

Instead of a continuous cross-section—such as a square or circular cross-section—the radiation pattern may also consist of two or more spatially separated individual beams, increasing the information content of a single measurement.

Measurement information from the at least one sensor, describing the projection position on the light-sensitive surface, is then transmitted-preferably to an external computation unit. The measurement information preferably includes a position of the projection on the light-sensitive surface, a shape of the projection, and an orientation of the projection on the light-sensitive surface.

The at least one radiation pattern comprises at least one laser beam, for example with a circular, rectangular, or oval cross-section. Other arbitrary cross-sectional geometries are also conceivable. The radiation pattern may, for example, be generated by a diffractive optical element. This diffractive optical element may split a single laser beam into multiple distinct, unconnected laser beams, which are understood in the context of the invention as separate and independent laser beams. Each laser beam preferably consists of individual beams with no or only minimal beam divergence.

During execution of the method according to some aspects of the invention, the robot is moved by the control unit into a plurality of joint configurations in which the at least one radiation pattern is detected by the at least one sensor, i.e., impinges on the light-sensitive surface. Such joint configurations are referred to herein as measurement configurations.

Due to unavoidable external forces, such as gravity, torques of varying or identical magnitudes act on all elasticity elements of the robot. Since the elasticity elements exhibit a certain elasticity, they respond to the torques induced by the external forces with slight elastic deformation, which results in operational inaccuracies of the robot. These elastic deformations are among the non-geometric error influences. Accordingly, the uncorrected robot structure information is erroneous due to unconsidered or incorrect non-geometric error influences.

The method according to some aspects of the invention is now characterized in that the at least one radiation pattern is projected through the workspace in such a way and the plurality of measurement configurations is selected in such a way that, for at least one elasticity element from the plurality of elasticity elements, there exists at least one pair of measurement configurations for which the absolute value of the difference in torques at the elasticity element is greater than a predefined threshold, and that a deviation on the light-sensitive surface of the at least one sensor is considered from a line and/or plane implicitly defined by the radiation pattern and its direction and orientation, by comparing, for each of the plurality of measurement configurations, the projection position detected by the at least one sensor with a projection position computed based on erroneous robot structure information, and that corrected robot structure information is derived from the deviation to compensate for the non-geometric error influences.

According to some aspects of the invention, it is provided that a model-based parameter identification is carried out, wherein the corrected global structure information comprises corrected model parameters of a mathematical model of the robot, the at least one radiation pattern generator, and the at least one sensor. The model parameters include robot parameters describing the robot and calibration object parameters describing the at least one radiation pattern generator and the at least one sensor. The plurality of measurement configurations consists of at least one measurement series, each of which includes all configurations recorded using a selected pair of calibration objects.

For the calculation of the corrected robot structure information, a mathematical model or mathematical description of the robot's kinematic structure as well as of the non-geometric and geometric error influences is implemented in the computation unit. In model-based robot calibration, the robot structure information is referred to as robot parameters of the model. The calibration object parameters describe the position of the at least one sensor relative to the effector and of the at least one radiation pattern generator relative to the robot base. The mathematical model describes, for each given joint configuration, the position of the effector and thus of the at least one sensor. Once the position of the radiation pattern generator is known, the position of the projection on the sensor in the sensor coordinate system can be computed using the mathematical model.

According to some aspects of the invention, the corrected robot parameters are calculated iteratively by the computation unit. The goal of the iterative computation process is to minimize a residual or average deviation between the calculated projection positions and those detected by the sensor.

With each iteration, improved model parameters are obtained, which increasingly approximate the actual, corrected model parameters, though they are still subject to some residual error.

According to some aspects of the invention, the corrected robot parameters are determined by the computation unit using a characteristic equation system, which may also be expressed as a characteristic matrix equation. The characteristic equation system is derived from a general kinematic system of equations and additionally incorporates the positions of the calibration objects.

In contrast to a purely kinematic system, the characteristic equation system takes into account the calibration method used, the associated calibration objects, and their spatial arrangement. The characteristic equation system can be formulated using homogeneous transformation matrices and represented as a characteristic matrix equation. Preferably, each side of the characteristic equation describes the position of the radiation pattern on the light-sensitive sensor surface, as further detailed below.

According to some aspects of the invention, the characteristic equation system is formulated as follows:

$$P \times L = {G}_{0} \times {G}_{1} \times … \times {G}_{n} \times S$$

wherein:
P describes the position of the at least one radiation pattern generator relative to the robot (110),
L describes the propagation direction of the at least one radiation pattern,
G₀×G₁× . . . ×Gₙ represents a spatial transformation from the robot base to the effector (117), and
each Gᵢ describes a transformation from one rigid body of the robot to the next rigid body, including the corresponding joint, or from one joint to the next joint, including the intermediate rigid body,
n denotes the number of joints of the robot, and
S describes a spatial transformation from the effector of the robot to an arbitrary but fixed coordinate system on the light-sensitive surface of the at least one sensor.

The characteristic equation is obtained by successively describing the transformations from the robot base to the first joint, then from joint to joint, and finally from the last joint to the sensor and to the predicted position of the radiation pattern on the sensor. These transformations are mathematically linked together and the resulting projection is compared to the measured position of the radiation pattern on the sensor.

According to some aspects of the invention, it is further provided that the computation unit derives a Jacobian matrix from the characteristic equation system, which computationally relates an infinitesimal change in the deviation to an infinitesimal change in the robot parameters.

The use of the Jacobian matrix for iterative parameter identification has proven to be an effective approach for determining optimal approximate solutions of overdetermined nonlinear systems of equations.

According to some aspects of the invention, the computation unit calculates a pseudoinverse of the Jacobian matrix.

The pseudoinverse of a matrix is a generalization of the inverse matrix to non-square matrices and is therefore often referred to as the generalized inverse.

According to some aspects of the invention, the corrected robot parameters are determined by the computation unit via model-based mathematical parameter identification, and the process includes at least one computation step executed as a nonlinear optimization.

Suitable methods for performing the at least one computation step as a nonlinear optimization include, for example, the Gauss-Newton method and the Levenberg-Marquardt method, which have proven effective for identifying accurate values of the robot parameters in the characteristic equation system.

According to some aspects of the invention, it is provided that the corrected robot structure information is contained in weighting matrices, wherein the weighting matrices are created and/or parameterized by a machine learning method and/or by artificial intelligence. In this case, the method according to some aspects of the invention is thus not executed in a model-based manner.

The weighting matrices contain the information of the mathematical model, but the model parameters do not appear explicitly within the matrices.

According to some aspects of the invention, it is provided that the at least one radiation pattern generator is arranged in such a way that an angle between the propagation direction of the at least one radiation pattern and the direction of gravity has a magnitude between 30° and 150°.

If the angle is 90°, the radiation pattern is projected horizontally through space. This ensures that, in many of the measurement configurations, large torques act on the elasticity elements of the robot. The greater the torques acting during the measurements, the more pronounced the errors resulting from incorrect or missing elasticity parameters manifest themselves in the deviations from the laser beam.

According to some aspects of the invention, it is provided that the at least one radiation pattern comprises at least two rigidly connected laser beams with an enclosed angle of less than 5 degrees or at least two crossed light planes.

In this case, the distance between the parallel laser beams should be sufficiently small such that, in suitable measurement configurations, both beams simultaneously impinge on the light-sensitive surface of the sensor.

According to some aspects of the invention, it is provided that the threshold value amounts to 5% of the computationally maximum possible absolute value of all pairwise differences in torques that any pair of practically or theoretically measurable measurement configurations may exhibit at the at least one elasticity element.

According to some aspects of the invention, it is provided that the external force is a gravitational force, a compressive force, or a torsional force. These are the external forces that typically act on the robot.

The gravitational force acts constantly and in every joint configuration on the robot. The torque resulting from gravity acting on one or more elasticity elements is substantially influenced by the orientation of the respective elasticity elements.

The compressive force acts on the robot or its elasticity elements when the robot presses a workpiece—or more generally, the effector—against another object, such as a tool or a workpiece, thereby compressing the elasticity elements. This may also result in a torque.

The torsional force, for example, acts when the robot rotates a workpiece against resistance—for instance, when a screw is driven into a thread with a certain torque. The same torque then acts on the elasticity elements of the robot.

According to some aspects of the invention, it is provided that the robot (110) is repeatedly moved into the plurality of measurement configurations and/or into subsets thereof while carrying different additional weights or payloads.

These different payloads may correspond, for example, to the full or half weight that the robot would handle or move during productive operation. Another important special case is when no additional payload is carried at all.

According to some aspects of the invention, it is provided that the corrected robot structure information is generated for a predefined subset of the elasticity elements of the robot.

This yields additional information that can be used in the determination of the corrected robot structure information.

Some aspects of the invention also relate to an apparatus for compensating non-geometric error influences on the absolute accuracy of a robot using a laser sensor system, comprising:
a robot with a plurality of elasticity elements and a control unit,
at least one radiation pattern generator,
at least one sensor with at least one light-sensitive surface,
   wherein an elasticity element may be a rigid body, a joint, an effector, or a robot base, wherein at least one radiation pattern generator is stationarily arranged in the environment of the robot, either within or outside the workspace, wherein the at least one radiation pattern generator is configured to emit at least one radiation pattern through the workspace of the robot, the pattern comprising at least one laser beam and/or at least one laser light plane, wherein the at least one sensor with the at least one light-sensitive surface is arranged on the effector of the robot, wherein the control unit is configured to move the robot, according to robot structure information stored electronically in the control unit, sequentially into a plurality of measurement configurations (I, II, III, IV) in which the at least one radiation pattern impinges on the at least one light-sensitive surface, and wherein the sensor is further configured to detect a projection position of the at least one radiation pattern on the at least one light-sensitive surface and to transmit measurement information describing the position to a computation unit.

According to some aspects of the invention, the apparatus is configured to carry out the method according to the method steps laid out in the various claims.

As a result, the advantages described in connection with the method of some aspects of the invention also apply to the inventive apparatus.

According to some aspects of the invention, it is provided that the computation unit is functionally and structurally integrated into the control unit. This offers the advantage that the method according to some aspects of the invention can be carried out by the robot without the need for an additional external computation unit. According to some aspects of the invention, it is provided that the at least one sensor comprises a housing, a diffusion plate, and a matrix camera, wherein the diffusion plate is a surface section of the housing and the matrix camera is enclosed by the housing, wherein the refraction property of the diffusion plate is configured such that an incident light beam at an angle of 45° causes a displacement of a light spot of less than 0.3 mm between the front and rear sides of the plate, wherein the matrix camera is arranged such that it can capture an image of the diffusion plate, and wherein the matrix camera is configured to output information about the captured image.

This embodiment of the at least one sensor is comparatively cost-effective, while still enabling reliable detection and recognition of the shape and position of the radiation pattern projection.

The outputted information preferably comprises pixel data from the matrix camera, i.e., information about which pixels of the matrix camera have detected the radiation pattern and transmit this data to the computation unit as previously described.

The matrix camera is preferably configured and adjusted such that, for a given maximum ambient light intensity and a given light intensity of the radiation pattern, the contrast between an impinging radiation pattern and the unilluminated area of the diffusion plate is always sufficient to reliably and losslessly detect the radiation pattern via the matrix camera, or such that at least a threshold value for radiation intensity can be predefined, above which it is ensured that the detected radiation originates from the radiation pattern.

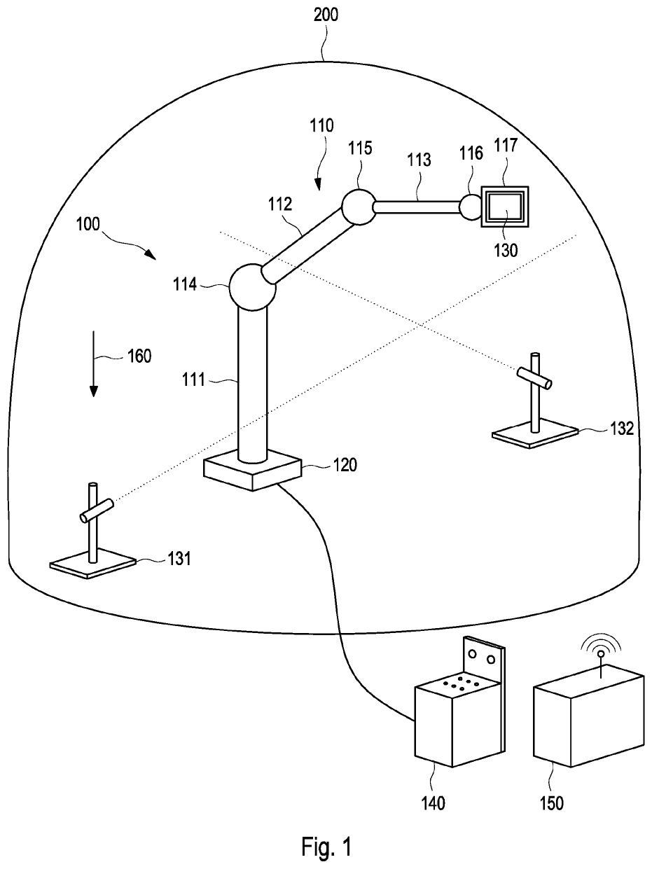

FIG. 1 shows, by way of example and schematically, a possible embodiment of an apparatus (100) according to some aspects of the invention for compensating non-geometric error influences on the absolute accuracy of a robot (110) using a laser sensor system.

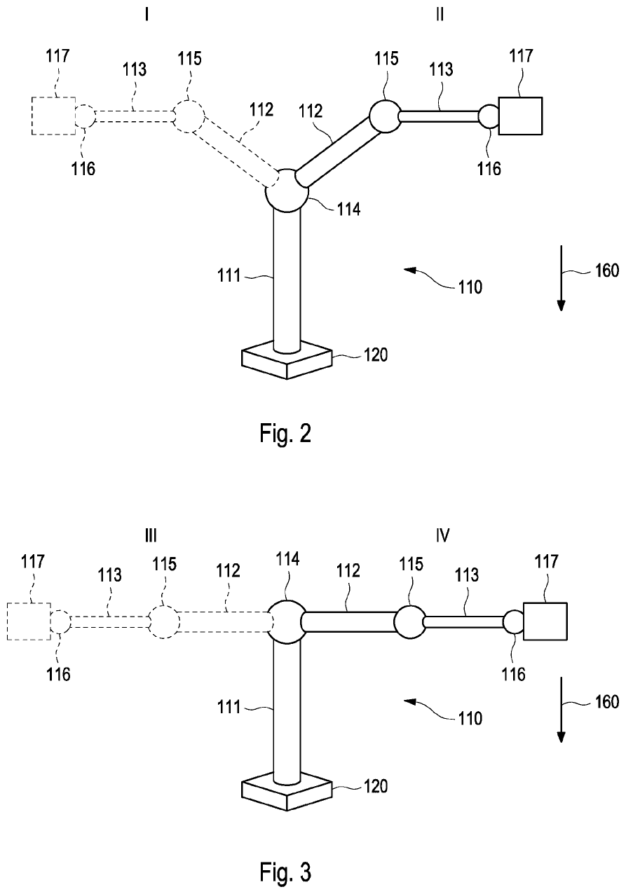

FIG. 2 shows, by way of example and schematically, the robot (110) in two different measurement configurations (I, II).

FIG. 3 shows, by way of example and schematically, the robot (110) from FIG. 2 in two additional, different measurement configurations (III, IV).

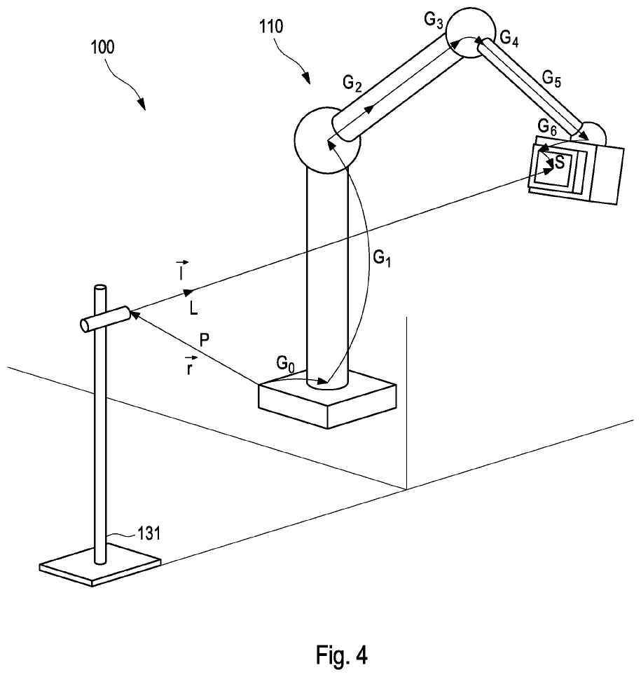

FIG. 4 shows, by way of example and schematically, another possible embodiment of an apparatus (100) according to some aspects of the invention.

Identical elements, functional units, and comparable components are labeled with the same reference numerals across the figures. These elements are technically identical unless explicitly or implicitly stated otherwise in the description.

FIG. 1 shows, by way of example and schematically, an apparatus (100) according to some aspects of the invention for compensating non-geometric error influences on the absolute accuracy of a robot (110) using a laser sensor system. The apparatus (100) comprises, for example, the robot (110) and the laser sensor system.

The robot (110) is exemplarily implemented as an industrial robot (110) intended for processing workpieces (not shown in FIG. 1) in a production environment.

The robot (110) comprises, for example, a plurality of elasticity elements (111, 112, 113, 114, 115, 116, 117, 120) and further elasticity elements not explicitly shown in FIG. 1. Among these are the ball joints (114, 115, 116).

The robot (110) is stationarily positioned in the workspace (200) via its robot base (120), which is also elastically deformable under force and thus constitutes an elasticity element (120).

The further elasticity elements (111, 112, 113, 114, 115, 116, 117) are partially formed as rigid bodies (111, 112, 113) and partially as joints (114, 115, 116). The rigid bodies (111, 112, 113) represent, for example, arm segments of the robot (110) that interconnect the joints (114, 115, 116). The joints (114, 115, 116) are shown here as ball joints. Another elasticity element is the effector (117), to which an optical sensor (130) with a light-sensitive surface is attached.

The apparatus (100) also comprises a control unit (140), which is connected to the robot (110) via a wired data connection and is arranged outside the workspace (200). The control unit (140) is implemented as a computer device and, via suitable control software, is configured to control the robot (110), specify joint configurations, and read joint positions. The control unit (140) further comprises a human-machine interface (HMI) via which a human operator can input commands for controlling or servicing the robot (110).

The apparatus (100) further comprises the already mentioned optical sensor (130) and two radiation pattern generators (131, 132). The control unit (140) may be arranged within the robot's workspace and/or additionally or alternatively outside the workspace. The control unit (140) may, alternatively, we included within the robot.

The two radiation pattern generators (131, 132) are stationarily mounted in the workspace (200) with fixed orientations.

The arrangement of the radiation pattern generators (131, 132) in the workspace (200) is such that a first radiation pattern from generator (131) is emitted at an angle of 30° relative to the direction of gravity (indicated by arrow 160), and a second radiation pattern from generator (132) is emitted at an angle of 25° to gravity.

The control unit (140) is configured to sequentially move the robot (110) into a plurality of measurement configurations based on electronically stored robot structure information. For this, it uses a mathematical model that represents the robot (110) via robot parameters. These robot parameters describe the geometric and non-geometric characteristics of the robot (110). Together with the calibration object parameters—which describe the positions and orientations of the radiation pattern generators (131, 132) relative to the robot base (120)—they form the model parameters.

When a radiation pattern impinges on the light-sensitive surface of sensor (130), the sensor detects the precise projection position. In other words, it detects the projection of the radiation pattern on the surface.

The sensor (130) then transmits measurement data describing the projection position—e.g., wirelessly—to a computation unit (150). Similarly, the control unit (140) transmits data describing the current measurement configuration to the computation unit (150).

Since the robot structure information stored in the control unit (140) has not yet been corrected, the resulting data is error-prone. Accordingly, deviations arise between the nominal projection positions and the actual measured ones. These deviations are primarily due to gravitational forces acting on the elasticity elements (111 to 117, 120), which induce configuration-dependent elastic deformations.

The two radiation patterns are projected through the workspace (200) in such a way that the set of measurement configurations includes at least one configuration pair for each elasticity element to be identified, for which the absolute value of the gravitational torque difference exceeds a threshold.

The computation unit (150) now calculates, from the projection deviations, the corrected robot structure information or corrected model parameters using an iterative procedure—starting, for example, from a characteristic equation system.

In some aspects of the invention shown in FIG. 1, the computation unit (150) and control unit (140) are implemented as a neural network, which uses artificial intelligence to generate the corrected robot structure information. In this case, the robot structure information is stored in weighting matrices derived from the collected measurement data. These matrices encode the model information without explicitly including the model parameters.

FIG. 2 shows, by way of example and schematically, the robot (110) in two different measurement configurations I and II. Configuration I is shown with dashed lines, while configuration II is shown with solid lines.

In both configurations I and II, a gravity-induced torque acts on the elasticity elements (111, 112, 113, 114, 115, 116, 117, 120). A notable feature here is that joints (115) and (116) are maximally loaded in opposite directions in the two configurations, resulting in the maximum absolute value of the torque difference at these joints. This occurs because rigid body (113), joint (116), and effector (117) are held perpendicular to the gravitational force vector (160) in both configurations.

These torques act differently on each elasticity element depending on the specific measurement configuration.

For example, in configuration I, a counterclockwise torque acts on joint (114), caused by the gravitational force acting on the subsequent elasticity elements (112, 113, 115, 116, 117), which are supported by joint (114).

Joint (115) experiences a counterclockwise torque in configuration I as well, caused by the gravitational force acting on the subsequent components (113, 116, 117). Joint (116) also experiences a maximum torque in this configuration.

When the robot (110) is moved into configuration II—which, for example, is a mirror image of configuration I across a vertical axis—the torques on joints (114, 115, 116) act in the opposite direction compared to configuration I.

Accordingly, the absolute difference in torque between configurations I and II is maximal for joints (115) and (116), whereas the torque difference at joint (114) is not maximal in this pair.

FIG. 3 shows, by way of example and schematically, the robot (110) from FIG. 2 in two additional measurement configurations III and IV. Configuration III is shown with dashed lines, configuration IV with solid lines.

Unlike in FIG. 2, here joint (114) is also maximally loaded in opposite directions between the two configurations III and IV.

In the dashed configuration III, the elasticity elements (112, 113, 115, 116, 117) following joint (114) are extended perpendicular to gravity, causing a maximum counterclockwise torque at joint (114).

In configuration IV, the same elasticity elements are again extended perpendicular to gravity. However, in this configuration the torque direction at joint (114) is reversed compared to configuration III, resulting in a maximum clockwise torque.

Thus, configurations III and IV form a mirrored pair across a vertical axis, and the absolute torque difference at joint (114) is maximal between these two configurations.

The torque values at joints (115) and (116) in configurations III and IV are the same as described previously in FIG. 2.

FIG. 4 shows, by way of example and schematically, other aspects of an apparatus (100). The apparatus comprises the robot (110) and the radiation pattern generator (131), positioned at a distance from each other within the workspace (200).

FIG. 4 illustrates the geometric setup of the robot (110) and the radiation pattern generator (131) as modeled in the characteristic equation system.

The robot (110) again comprises, for example, the three ball joints (114, 115, 116). The corresponding joint transitions are described by homogeneous 4×4 matrices denoted as G₁ through G₆.

The origin of the robot base coordinate system is located, for example, at the upper left corner of the base (120). The transformation from this point to the first rigid segment (111) is represented by the transfer matrix G₀.

The radiation pattern generator (131) emits a radiation pattern. The emission point relative to the upper left corner of the robot base (120) is given by vector **p^{→}***, or the transformation matrix **P**. The propagation direction of the radiation is denoted **I^{→}***. The pattern impinges on the optical sensor (130) at a point described relative to a local sensor coordinate system on the light-sensitive surface using a coordinate pair or transformation matrix **S**. The distance between the emission and projection point is denoted |**I^{→}**|. The transfer matrix from the emission point to the projection point over this distance is represented by **L**.

The characteristic equation can thus be written as:

$${}^{**} P \times L = {G}_{0} \times {G}_{1} \times {G}_{2} \times {G}_{3} \times {G}_{4} \times {G}_{5} \times {G}_{6} \times {S}^{⋆ ⋆}$$

The linearity of the laser beam—being perfectly straight—is encoded by matrix **L**, which models the straight-line propagation with a fixed direction vector and a scalar parameter.

This linearity, together with the specific spatial arrangement of the calibration objects (sensor 130 and generator 131), is integrated into the mathematical model.

Together with the modeled elasticity of the elasticity elements (111-117, 120), this mathematical model can now be subjected to a nonlinear optimization or other suitable iterative method to determine the elasticity values and correct the erroneous model parameters.

Subsets or combinations of various aspects described above provide further aspects. These and other changes can be made to various aspects of the invention in light of the above-detailed description and still fall within the scope of the present invention. In general, in the following claims, the terms used should not be construed to limit the invention to the specific aspects disclosed in the specification. Accordingly, the invention is not limited by the disclosure, but instead its scope is to be determined entirely by the following claims.

### REFERENCE NUMERAL LIST

100 Apparatus
110 Robot, industrial robot
111, 112, 113 Elasticity element, rigid body
114, 115, 116 Elasticity element, joint
117 Elasticity element, effector
120 Robot base
130 Optical sensor
131 Radiation pattern generator, semiconductor laser diode
132 Radiation pattern generator, semiconductor laser diode
140 Control unit
150 Computation unit
160 Gravity
200 Workspace
r Direction vector
I Distance
G₀, G₁, G₂, G₃, G₄, G₅, G₆, Transformation matrices
S, P, L
I, II, III, IV Measurement configurations

1. A method for compensating non-geometric error influences on an absolute accuracy of a robot using a laser sensor system,
wherein the robot includes a plurality of elasticity elements and is controlled by a control unit,
wherein an elasticity element of the plurality of elasticity elements is a rigid body, a joint, an effector, or a robot base,
wherein at least one radiation pattern generator is stationarily arranged in an environment of the robot within or outside of a working space, the at least one radiation pattern generator configured to emit at least one radiation pattern by the at least one radiation pattern generator through the working space of the robot, the at least one radiation pattern including at least one laser beam or at least one laser light plane,
wherein at least one sensor with at least one light-sensitive surface is arranged on the effector of the robot,
wherein the robot is controlled via the control unit sequentially into a plurality of measurement configurations in which the at least one radiation pattern impinges on the at least one light-sensitive surface,
wherein the robot is controlled according to robot structure information stored electronically in the control unit,
wherein a position of a projection of the at least one radiation pattern on the at least one light-sensitive surface is detected by the at least one sensor, and measurement information describing the position is transmitted from the at least one sensor to a computation unit,
wherein torques act on the elasticity elements due to an external force depending on the respective joint configuration, and
wherein the robot structure information is erroneous due to non-geometric error influences,
the method comprising:
emitting the at least one radiation pattern through the working space and selecting the plurality of measurement configurations in such a way that, for at least one elasticity element from the plurality of elasticity elements, there exists at least one pair of measurement configurations in which the absolute value of the difference of the torques at the at least one elasticity element is greater than a threshold value;
determining a deviation on the light-sensitive surface of the at least one sensor from a line and/or plane, which is implicitly defined by the radiation pattern and its direction and orientation, by comparing, for the plurality of measurement configurations the position of the projection detected by the at least one sensor with a computed projection position based on the erroneous robot structure information; and
generating corrected robot structure information from the deviation to compensate for the non-geometric error influences.

2. The method according to claim 1, further comprising performing a model-based parameter identification by a computation unit,
wherein the corrected robot structure information includes corrected model parameters of a mathematical model of the robot, the at least one radiation pattern generator, and the at least one sensor,
wherein the model parameters include robot parameters describing the robot and calibration object parameters describing the at least one radiation pattern generator and the at least one sensor,
wherein the plurality of measurement configurations include at least one measurement series, and
wherein the at least one measurement series includes all measurement configurations recorded with a selected pair of calibration objects.

3. The method according to claim 2, further comprising iteratively calculating the corrected robot parameters by the computation unit.

4. The method according to claim 2,
wherein the corrected robot parameters are computed by the computation unit using a characteristic equation system, which may be represented in the form of a characteristic matrix equation, and
wherein the characteristic equation system is derived from a general kinematic equation system and additionally includes the position of the selected pair of calibration objects.

5. The method according to claim 4,
wherein the characteristic equation system is expressed in the form:
$$P * L = G 0 * G 1 * … * Gn * S$$
wherein P describes a position of the at least one radiation pattern generator relative to the robot,
wherein L describes a direction of the at least one radiation pattern,
wherein G0*G1* . . . *Gn describes a spatial transformation from the robot base to the effector, each Gi represents a transformation from one rigid body of the robot to the next rigid body including the associated joint, or from one joint to the next joint including the intermediate rigid body,
wherein n denotes the number of joints of the robot, and
wherein S describes a spatial transformation from the effector of the robot to an arbitrary but fixed coordinate system on the light-sensitive surface of the at least one sensor.

6. The method according to claim 4, wherein a Jacobian matrix is generated by the computation unit based on the characteristic equation system, which computationally relates an infinitesimal change in the deviation to an infinitesimal change in the robot parameters.

7. The method according to claim 6, wherein a pseudoinverse of the Jacobian matrix is computed by the computation unit.

8. The method according to claim 2, wherein the corrected robot parameters are calculated by the computation unit using model-based mathematical parameter identification, comprising at least one computation step executed as a nonlinear optimization.

9. The method according to claim 1,
wherein the corrected robot structure information is contained in weighting matrices, and
wherein the weighting matrices are generated or parameterized by a machine learning method or by artificial intelligence.

10. The method according to claim 1, wherein the at least one radiation pattern generator is arranged such that an angle between a propagation direction of the at least one radiation pattern and a direction of gravity has a magnitude between 30° and 150°.

11. The method according to claim 1, wherein the at least one radiation pattern comprises at least two rigidly connected laser beams with an enclosed angle of less than 5 degrees, or at least two crossed light planes.

12. The method according to claim 1, wherein the threshold value amounts to 5% of the computationally maximum possible absolute value of all pairwise differences in torques that any pair of practically or theoretically measurable measurement configurations can have at the at least one elasticity element.

13. The method according to claim 1, wherein the external force is gravity, a compressive force, or a torsional force.

14. The method according to claim 1, wherein the robot is repeatedly controlled into the plurality of measurement configurations or subsets thereof with different additional weights or payloads.

15. An apparatus for compensating non-geometric error influences on an absolute accuracy of a robot using a laser sensor system, comprising:
a control unit;
a robot having a plurality of elasticity elements;
at least one radiation pattern generator; and
at least one sensor with at least one light-sensitive surface,
wherein an elasticity element of the plurality of elasticity elements is a rigid body, a joint, an effector, or a robot base,
wherein at least one radiation pattern generator is stationarily arranged in an environment of the robot within or outside of a working space, the at least one radiation pattern generator configured to emit at least one radiation pattern by the at least one radiation pattern generator through the working space of the robot, the at least one radiation pattern including at least one laser beam or at least one laser light plane,
wherein the at least one radiation pattern comprises at least one laser beam or at least one laser light plane,
wherein the at least one sensor with the at least one light-sensitive surface is arranged on the effector of the robot,
wherein the control unit is configured to control the robot sequentially into a plurality of measurement configurations in which the at least one radiation pattern impinges on the at least one light-sensitive surface according to robot structure information stored electronically in the control unit, and
wherein the sensor is further configured to detect a position of a projection of the at least one radiation pattern on the at least one light-sensitive surface and to transmit measurement information describing the position to a computation unit,
wherein the control unit is configured to control the apparatus to:
emit the at least one radiation pattern through the working space and select the plurality of measurement configurations in such a way that, for at least one elasticity element from the plurality of elasticity elements, there exists at least one pair of measurement configurations in which the absolute value of the difference of the torques at the at least one elasticity element is greater than a threshold value;
determine a deviation on the light-sensitive surface of the at least one sensor from a line and/or plane, which is implicitly defined by the radiation pattern and its direction and orientation, by comparing, for the plurality of measurement configurations the position of the projection detected by the at least one sensor with a computed projection position based on the erroneous robot structure information; and
generate corrected robot structure information from the deviation to compensate for the non-geometric error influences.

16. The apparatus according to claim 15,
wherein the at least one sensor comprises a housing, a diffusion plate, and a matrix camera,
wherein the diffusion plate is a surface section of the housing and the matrix camera is enclosed by the housing,
wherein a refraction property of the diffusion plate is configured such that an incident light beam at an angle of 45° causes a displacement of a light spot of less than 0.3 mm between the front and rear sides of the plate,
wherein the matrix camera is arranged to capture an image of the diffusion plate, and
wherein the matrix camera is configured to output information about the captured image.
